(19) United States
(12) Patent Application Publication
(10) Pub. No.: US 2024/0280220 A1
(43) Pub. Date: Aug. 22, 2024

(54) CRYOGENIC TANK DEVICE WITH A BOIL-OFF MANAGEMENT SYSTEM

(71) Applicant: MAGNA Energy Storage Systems GesmbH, Sinabelkirchen (AT)

(72) Inventors: Florian WIMMER, Riegersburg (AT); Matthaeus JAEGER, Trieben (AT); Rainer PUCHLEITNER, Graz (AT)

(73) Assignee: MAGNA Energy Storage Systems GesmbH, Sinabelkirchen (AT)

(21) Appl. No.: 18/424,807

(22) Filed: Jan. 28, 2024

(30) Foreign Application Priority Data
Feb. 20, 2023 (DE) 102023201447.5

(51) Int. Cl. F17C 7/04; F17C 13/00; F17C 13/12

(52) U.S. Cl. CPC F17C 7/04; F17C 13/126; F17C 13/002; F17C 2205/0332; F17C 2205/0352; F17C 2223/0161; F17C 2260/037; F17C 2260/042; F17C 2260/05; F17C 2265/03

(57) ABSTRACT

A cryogenic tank apparatus having a first cryogenic tank having a first medium therein; a first boil-off conduit fluidically connected to the first cryogenic tank, the first boil-off conduit having a first boil-off valve; a first nozzle fluidically connected to the first boil-off conduit; a second cryogenic tank having the first medium therein; a second boil-off conduit fluidically connected to the second cryogenic tank; and a boil-off management system (BOMS) to receive flow of the first medium from the first cryogenic tank through the first nozzle, and flow of the first medium from the second cryogenic tank. The BOMS has a mixing chamber, a catalyst downstream of the mixing chamber, an outlet of downstream of the catalyst, and an air supply conduit through which flows a second medium, the mixing chamber being operable for mixing the first medium from the first cryogenic tank and the first medium from the second cryogenic tank with the second medium from the air supply conduit.

### CROSS-REFERENCE TO RELATED APPLICATIONS

The present application claims priority under 35 U.S.C. § 119 to German Patent Publication No. DE 102023201447.5 (filed on Feb. 20, 2023), which is hereby incorporated by reference in its complete entirety.

### TECHNICAL FIELD

One or more embodiments of the present disclosure relates to a cryogenic tank apparatus having a boil-off management system, especially a mobile cryogenic tank apparatus.

### BACKGROUND

Cryogenic tanks, i.e., cryostat vessels or pressurized reservoirs for cryogenic liquefied gases, for example for a fuel cell vehicle operated with liquid hydrogen (H2), are known per se and are used for storage of cryogenic liquids, especially of liquid hydrogen. The medium may especially be used as fuel for a land-based or airborne means of locomotion, for example for a vehicle, aircraft or space rocket. Cryogenic tanks typically have an internal vessel, i.e., internal tank, which accommodates the medium stored in the tank, i.e., the hydrogen in particular, and an outer vessel surrounding the inner vessel. There is typically an insulated space, especially with a vacuum, set up between the inner vessel and outer vessel, in order to reduce heat transfer from the outside inward. Such cryogenic tanks may be cylindrical.

The unavoidable input of heat into a cryogenic tank results in constant evaporation of hydrogen. It is possible thereby to keep the temperature in the tank constant (called “boil-off”). In order to keep the pressure in the internal vessel below a particular threshold, a valve (called the “boil-off valve,” BOV) opens therein, which releases gaseous hydrogen into the environment. In order to rule out endangerment (for example explosion) as a result of excessively high hydrogen concentrations in the environment, the gas released can be catalytically converted with oxygen in the ambient air and hence reacts to give water vapour. This system for mixing and catalytic conversion of the gas released is referred to as a “boil-off management system” (BOMS). Since a sufficient amount of gaseous hydrogen is always removed during the operation of a hydrogen vehicle, or can be removed for operation, the BOMS is typically required only in the case of a prolonged dormancy time of the vehicle. Once the boil-off valve opens, the hydrogen released flows out, and is mixed with air and catalytically converted.

As of recently, cryogenic tank apparatuses comprising more than one cryogenic tank have also been used, in order, for example, to be able to transport greater amounts of hydrogen in a vehicle.

### SUMMARY

One or more embodiments of the present disclosure are to specify a cryogenic tank apparatus that can store large amounts of hydrogen and can maintain a desired pressure in the cryogenic tank apparatus in an inexpensive and space-saving manner.

In accordance with one or more embodiments, a cryogenic tank apparatus comprising: a first cryogenic tank having a first medium therein; a first boil-off conduit fluidically connected to the first cryogenic tank, the first boil-off conduit having a first boil-off valve; a first nozzle fluidically connected to the first boil-off conduit; a second cryogenic tank having the first medium therein; a second boil-off conduit fluidically connected to the second cryogenic tank; and a boil-off management system (BOMS) to receive flow of the first medium from the first cryogenic tank through the first nozzle, and flow of the first medium from the second cryogenic tank, the BOMS having a mixing chamber, a catalyst downstream of the mixing chamber, an outlet of downstream of the catalyst, and an air supply conduit through which flows a second medium, the mixing chamber being operable for mixing the first medium from the first cryogenic tank and the first medium from the second cryogenic tank with the second medium from the air supply conduit.

In accordance with one or more embodiments, a cryogenic tank apparatus comprising two cryogenic tanks is used, namely a first cryogenic tank and a second cryogenic tank. The first cryogenic tank and the second cryogenic tank are fluidically connected to a BOMS via respective boil-off conduits, with use of just a single BOMS for both the first cryogenic tank and the second cryogenic tank. For this purpose, the second boil-off conduit that proceeds from the second cryogenic tank is likewise fluidically connected to the same BOMS, and hence, to the same mixing chamber and the same catalyst as the first cryogenic tank. The sole BOMS preferably also has only a single housing.

In accordance with one or more embodiments, for the conversion of hydrogen, which evaporates over the course of prolonged dormancy times in the twin-tank system to water vapour, all that is thus used is a single BOMS, in particular, one housing and one of each component, for example, one catalyst, for both the first cryogenic tank and the second cryogenic tank. Functional units required, such as, in particular, Venturi tube, catalyst, nozzles, are designed so as to enable safe operation of the system with a single BOMS. This can save build space, and also components and costs, compared to the use of a respective dedicated BOMS. For the storage of a large amount of hydrogen, nevertheless, at least two cryogenic tanks, especially two internal tanks, are provided.

Developments of the invention are specified in the dependent claims, the description, and the appended drawings.

In accordance with one embodiment, preferably the first boil-off conduit and the second boil-off conduit are merged upstream of the first nozzle to form a common boil-off conduit, such that the medium flowing in through the common boil-off conduit via the first nozzle is mixed with the medium flowing in through the air supply conduit. The first boil-off conduit and the second boil-off conduit are thus merged upstream of the nozzle through which the hydrogen is introduced into the mixing chamber, by use of a simple connected conduit common to both the first cryogenic tank and the second cryogenic tank, i.e., at the connection of two boil-off conduits for removal of the hydrogen into just one BOMS.

The second boil-off conduit fluidically connected to the second cryogenic tank may have a dedicated second boil-off valve, such that the first boil-off conduit and the second boil-off conduit are merged only downstream of the first and second boil-off valve to give the common boil-off conduit.

In accordance with another embodiment, the first boil-off conduit and the second boil-off conduit can be merged upstream of the first boil-off valve to give the common boil-off conduit, such that the first boil-off valve constitutes a common boil-off valve for the first boil-off conduit and the second boil-off conduit.

In accordance with a further embodiment, the cryogenic tank apparatus for the second boil-off conduit comprises a second nozzle, such that the medium flowing in through the second boil-off conduit via the second nozzle in the mixing chamber is mixed in the mixing chamber with the medium flowing in through the air supply conduit.

As an alternative to the merging of the two gas streams upstream of the actual BOMS, more specifically upstream of the nozzle to the mixing chamber of the BOMS, it is possible by the use of two nozzles to achieve direct mixing and injection of the hydrogen into the BOMS. In that case, each boil-off conduit preferably again has a dedicated boil-off valve.

This design also makes it possible for a cost and weight advantage to arise as a result of the consolidation of housing and catalyst, and only the nozzles for injection of the hydrogen into the mixing chamber need be duplicated.

### BRIEF DESCRIPTION OF THE DRAWINGS

One or more embodiments of this disclosure will be illustrated by way of example in the drawings and explained in the description hereinbelow.

FIG. 1 is a schematic diagram of a cryogenic tank apparatus, in accordance with a first embodiment.

FIG. 2 is a schematic diagram of a cryogenic tank apparatus, in accordance with a second embodiment.

FIG. 3 is a schematic diagram of a cryogenic tank apparatus, in accordance with a third embodiment.

### DESCRIPTION

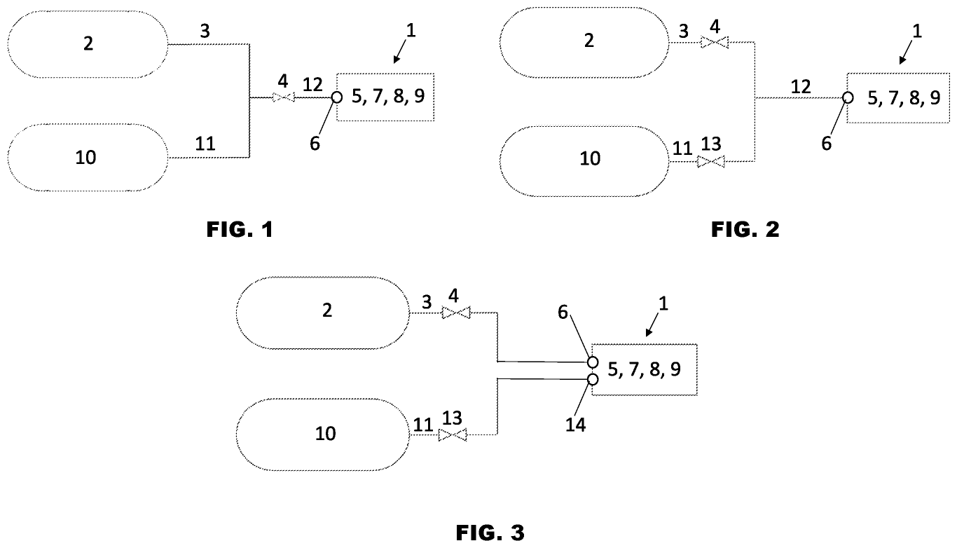

FIG. 1 shows a cryogenic tank apparatus in accordance with one or more embodiments, comprising a first cryogenic tank 2 and a first boil-off conduit 3 which has a first boil-off valve 4 and is fluidically connected to the first cryogenic tank 2. In addition, the cryogenic tank apparatus comprises a BOMS 1, comprising, in a housing, a mixing chamber 5 for mixing of the medium, especially hydrogen, flowing in through the first boil-off conduit 3 via a first nozzle 6 in the mixing chamber 5, with the medium, especially air and/or oxygen, flowing in through an air supply conduit 7, and a catalyst 8 downstream of the mixing chamber 5, and an outlet 9 of the boil-off management system 1 downstream of the catalyst 8.

The cryogenic tank apparatus additionally comprises a second cryogenic tank 10 and a second boil-off conduit 11 fluidically connected to the second cryogenic tank 10. The mixing chamber 5 which is utilized for the first boil-off conduit 3 is also set up to mix the medium flowing in through the second boil-off conduit 11 with the medium flowing in through the air supply conduit 7, such that the same BOMS 1, with the mixing chamber 5, with the catalyst 8 downstream of the mixing chamber 5, and with the outlet 9 downstream of the catalyst 8, is used for both the first boil-off conduit 3 of the first cryogenic tank 2 and the second boil-off conduit 11 of the second cryogenic tank 10.

In FIGS. 2 and 3, the first boil-off conduit 3 and the second boil-off conduit 11 are merged upstream of the first nozzle 6 to form a common boil-off conduit 12, such that the medium flowing in through the common boil-off conduit 12 via the first nozzle 6 is mixed with the medium flowing in through the air supply conduit 7.

In the embodiment of FIG. 1, the first boil-off conduit 3 and the second boil-off conduit 11 are merged upstream of the first boil-off valve 4 to form the common boil-off conduit 12, such that the first boil-off valve 4 constitutes a common boil-off valve for the first boil-off conduit 3 and the second boil-off conduit 11.

In the embodiment of FIG. 2, the second boil-off conduit 11 fluidically connected to the second cryogenic tank 10 has a second boil-off valve 13, such that the first boil-off conduit 3 and the second boil-off conduit 11 are merged only downstream of the first boil-off valve 4 and the second boil-off valve 13 to form the common boil-off conduit 12.

In the embodiment of FIG. 3, the cryogenic tank apparatus for the second boil-off conduit 11 comprises a second nozzle 14, such that the medium flowing in through the second boil-off conduit 11 via the second nozzle 14 in the mixing chamber 5 is mixed in the mixing chamber 5 with the medium flowing in through the air supply conduit 7. Thus, the first nozzle 6 and the second nozzle 14 are used for injection of the hydrogen from two different cryogenic tanks, namely the first cryogenic tank 2 and the second cryogenic tank 10, into a common BOMS 1.

### LIST OF REFERENCE SYMBOLS

1 boil-off management system
2 first cryogenic tank
3 first boil-off conduit
4 first boil-off valve
5 mixing chamber
6 first nozzle
7 air supply conduit
8 catalyst
9 outlet
10 second cryogenic tank
11 second boil-off conduit
12 common boil-off conduit
13 second boil-off valve
14 second nozzle

What is claimed is:

1. A cryogenic tank apparatus, comprising:
a first cryogenic tank having a first medium therein;
a first boil-off conduit fluidically connected to the first cryogenic tank, the first boil-off conduit having a first boil-off valve;
a first nozzle fluidically connected to the first boil-off conduit;
a second cryogenic tank having the first medium therein;
a second boil-off conduit fluidically connected to the second cryogenic tank; and
a boil-off management system (BOMS) to receive flow of the first medium from the first cryogenic tank through the first nozzle, and flow of the first medium from the second cryogenic tank, the BOMS having a mixing chamber, a catalyst downstream of the mixing chamber, an outlet of downstream of the catalyst, and an air supply conduit through which flows a second medium, the mixing chamber being operable for mixing the first medium from the first cryogenic tank and the first medium from the second cryogenic tank with the second medium from the air supply conduit.

2. The cryogenic tank apparatus of claim 1, wherein the first boil-off conduit and the second boil-off conduit are merged upstream of the first nozzle to form a common boil-off conduit, such that the first medium flowing in through the common boil-off conduit via the first nozzle is mixed with the second medium flowing in through the air supply conduit.

3. The cryogenic tank apparatus of claim 2, wherein the second boil-off conduit has a second boil-off valve, such that the first boil-off conduit and the second boil-off conduit are merged downstream of the first boil-off valve and the second boil-off valve to form the common boil-off conduit.

4. The cryogenic tank apparatus of claim 2, wherein the first boil-off conduit and the second boil-off conduit are merged upstream of the first boil-off valve to form the common boil-off conduit, such that the first boil-off valve constitutes a common boil-off valve for the first boil-off conduit and the second boil-off conduit.

5. The cryogenic tank apparatus of claim 1, wherein the second cryogenic tank comprises a second nozzle, such that the first medium flowing in through the second boil-off conduit via the second nozzle in the mixing chamber is mixed in the mixing chamber with the second medium.

6. The cryogenic tank apparatus of claim 1, wherein the first medium comprises hydrogen, and the second medium comprises air and/or oxygen.

7. A cryogenic tank apparatus, comprising:
a first cryogenic tank having a first medium therein;
a first boil-off conduit fluidically connected to the first cryogenic tank,
a second cryogenic tank having the first medium therein;
a second boil-off conduit fluidically connected to the second cryogenic tank;
a common boil-off conduit formed from a merger of the first boil-off conduit and the second boil-off conduit;
a nozzle fluidically connected to the common boil-off conduit; and
a boil-off management system (BOMS) fluidically connected to the nozzle to receive flow of the first medium, the BOMS having a mixing chamber and an air supply conduit through which flows a second medium, the mixing chamber being operable for mixing the first medium with the second medium.

8. The cryogenic tank apparatus of claim 7, further comprising a nozzle fluidically connected to the common boil-off conduit and the boil-off management system to facilitate transfer of the first medium to the boil-off management system.

9. The cryogenic tank apparatus of claim 7, wherein the common boil-off conduit has a boil-off valve.

10. The cryogenic tank apparatus of claim 7, wherein the first medium comprises hydrogen, and the second medium comprises air and/or oxygen.

11. A cryogenic tank apparatus, comprising:
a first cryogenic tank having a first medium therein;
a first boil-off conduit fluidically connected to the first cryogenic tank,
a second cryogenic tank having the first medium therein;
a second boil-off conduit fluidically connected to the second cryogenic tank;
a first nozzle fluidically connected to the first boil-off conduit;
a second nozzle fluidically connected to the second boil-off conduit; and
a boil-off management system (BOMS) fluidically connected to the first nozzle and the second nozzle to receive flows of the first medium from the first cryogenic tank and the second cryogenic tank, the BOMS having a mixing chamber and an air supply conduit through which flows a second medium, the mixing chamber being operable for mixing:
the first medium from the first cryogenic tank with the second medium from the air supply conduit, and
the first medium from the second cryogenic tank with the second medium from the air supply conduit.

12. The cryogenic tank apparatus of claim 11, further comprising a first nozzle fluidically connected to the first boil-off conduit and the boil-off management system to facilitate transfer of the first medium from the first cryogenic tank to the boil-off management system.

13. The cryogenic tank apparatus of claim 11, further comprising a second nozzle fluidically connected to the second boil-off conduit and the boil-off management system to facilitate transfer of the first medium from the second cryogenic tank to the boil-off management system.

14. The cryogenic tank apparatus of claim 11, further comprising:
a first nozzle fluidically connected to the first boil-off conduit and the boil-off management system to facilitate transfer of the first medium from the first cryogenic tank to the boil-off management system, and
a second nozzle fluidically connected to the second boil-off conduit and the boil-off management system to facilitate transfer of the first medium from the second cryogenic tank to the boil-off management system.

15. The cryogenic tank apparatus of claim 11, wherein the first boil-off conduit has a first boil-off valve.

16. The cryogenic tank apparatus of claim 11, wherein the second boil-off conduit has a second boil-off valve.

17. The cryogenic tank apparatus of claim 11, wherein:
the first boil-off conduit has a first boil-off valve, and
the second boil-off conduit has a second boil-off valve.

18. The cryogenic tank apparatus of claim 11, wherein the first medium comprises hydrogen, and the second medium comprises air.

19. The cryogenic tank apparatus of claim 11, wherein the first medium comprises hydrogen, and the second medium comprises oxygen.

20. The cryogenic tank apparatus of claim 11, wherein the first medium comprises hydrogen, and the second medium comprises air and oxygen.
